(19) United States
(12) Patent Application Publication
(10) Pub. No.: US 2010/0150304 A1
(43) Pub. Date: Jun. 17, 2010

(54) Radiation CT imaging apparatus

(75) Inventor: Takahiro Kawamura, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/654,142

(22) Filed: Dec. 11, 2009

(30) Foreign Application Priority Data
Dec. 12, 2008 (JP) 2008-316353

(51) Int. Cl. H05G 1/60; H05G 1/02

(52) U.S. Cl. 378/9; 378/196

(57) ABSTRACT

A plurality of radiation sources and a plurality of radiation detectors are integrated into a main imaging unit and a moving member is provided to the main imaging unit.

### BACKGROUND OF THE INVENTION

1. Field of the Invention

The present invention relates to a radiation CT imaging apparatus for obtaining a tomographic image of a subject.

2. Description of the Related Art

It has been practiced to take an X-ray image with a portable X-ray machine at a bedside of a seriously ill hospital patient who is unable to move to a radiography room for follow-up observations.

X-ray imaging with a conventional portable X-ray machine, however, can not provide sufficient observation information for a patient under intensive care or after operation, and it has been awaited for an apparatus capable of obtaining an image having sufficient observation information, such as a radiation CT image.

Consequently, for example, U.S. Pat. No. 7,570,734 proposes a portable radiation CT imaging apparatus having a C-arm gantry with a horizontal rotating shaft.

The radiation CT imaging apparatus described in U.S. Pat. No. 7,570,734, however, has a large size because of a rotation mechanism for rotating the C-arm gantry and it is very inconvenient to bring inside a room. Further, the C-arm gantry is rotated by the rotation mechanism so that a positional displacement may occur in the gantry which needs to be corrected, whereby the apparatus becomes complicated and increased cost.

In view of the circumstances described above, it is an object of the present invention to provide a radiation CT imaging apparatus downsized and increased in portability without a rotation mechanism.

### SUMMARY OF THE INVENTION

A first radiation CT imaging apparatus of the present invention is an apparatus, including a plurality of radiation sources, a plurality of radiation detectors, each provided at a position opposite to each radiation source, for detecting radiation emitted sequentially from each radiation source and transmitted through a subject, and a tomographic image generation unit for generating a tomographic image of the subject based on radiation image signals detected by the plurality of radiation detectors, wherein:

the plurality of radiation sources and the plurality of radiation detectors are integrated into a main imaging unit; and

a moving member is further provided to the main imaging unit for making the main imaging unit movable.

In the first radiation CT imaging apparatus of the present invention, the apparatus may further include a mounting table having a mounting board on which the subject is placed and a leg attached to a lower surface of the mounting board, the main imaging unit may be formed in a cylindrical shape, and the leg of the mounting board may be configured to be folded when the mounting table passes an inner cylinder side of the cylindrically shaped main imaging unit and the mounting board may be configured to be placed on an inner cylindrical surface.

Further, a rotatable rolling member for holding the mounting board may be provided on the lower surface of the mounting board or on the inner cylinder surface of the main imaging unit.

Still further, a rotatable rolling member for holding the mounting board may be provided on the inner cylinder surface of the main imaging unit, and a groove for fittingly receiving the rolling member may be formed in the lower side of the mounting board running in a longitudinal direction of the board.

Further, a floor groove for fittingly receiving the moving member may be formed in a floor, on which the mounting table is installed, running in a longitudinal direction of the mounting board.

Still further, the mounting board may be formed of a material having a low absorption rate for radiation.

A second radiation CT imaging apparatus of the present invention is an apparatus, including a plurality of radiation sources, a plurality of radiation detectors, each provided at a position opposite to each radiation source, for detecting radiation emitted sequentially from each radiation source and transmitted through a subject, and a tomographic image generation unit for generating a tomographic image of the subject based on radiation image signals detected by the plurality of radiation detectors, wherein:

the plurality of radiation sources and the plurality of radiation detectors are integrated into a main imaging unit; and

an arm member, having a first end connected to the main imaging unit and a second end to be movably held, and a rail for movably holding the arm member are further provided.

In the second radiation CT imaging apparatus of the present invention, the rail may be provided on a ceiling of a room.

According to the first radiation CT imaging apparatus of the present invention, a plurality of radiation sources and a plurality of radiation detectors are integrated into a main imaging unit, and a moving member is provided to the main imaging unit. This allows a downsized main imaging unit, which does not require a rotation mechanism, to be realized and the portability is improved.

In the first radiation CT imaging apparatus, if the main imaging unit is formed in a cylindrical shape, and the leg of the mounting board is configured to be folded when the mounting table passes an inner cylinder side of the cylindrically shaped main imaging unit and the mounting board is configured to be placed on an inner cylindrical surface, the main imaging unit may be set to the mounting table more smoothly.

Further, if a rotatable rolling member for holding the mounting board is provided on the lower surface of the mounting board or on the inner cylinder surface of the main imaging unit, the main imaging unit may be moved smoothly when imaging is performed by moving the main imaging unit.

Still further, if a rotatable rolling member for holding the mounting board is provided on the inner cylinder surface of the main imaging unit, and a groove for fittingly receiving the rolling member is formed in the lower side of the mounting board running in the longitudinal direction of the board, or if a floor groove for fittingly receiving the moving member is formed in a floor, on which the mounting table is installed, running in the longitudinal direction of the mounting board, the main imaging unit may be moved more smoothly and without positional displacement with respect to the subject placed on the mounting table when imaging is performed by moving the main imaging unit.

Further, if the mounting board is formed of a material having a low absorption rate for radiation, absorption of the radiation by the mounting board may be reduced and, for example, a metal artifact may be prevented.

According to the second radiation CT imaging apparatus of the present invention, the plurality of radiation sources and the plurality of radiation detectors are integrated into a main imaging unit, and an arm member, having a first end connected to the main imaging unit and a second end to be movably held, and a rail for movably holding the arm member are further provided. This allows a downsized main imaging unit, which does not require a rotation mechanism, to be realized and the portability is improved.

### BRIEF DESCRIPTION OF THE DRAWINGS

FIG. 1 is a perspective view of a first embodiment of a radiation CT imaging apparatus of the present invention, illustrating a schematic configuration thereof.

FIG. 2 is an X-Y plan view of an imaging body unit of the radiation CT imaging apparatus shown in FIG. 1.

FIG. 3 schematically illustrates the inside of the fixed gantry.

FIG. 4 illustrates the lower surface of a mounting board.

FIG. 5A illustrates an operation of the first embodiment of the radiation CT imaging apparatus of the present invention.

FIG. 5B illustrates an operation of the first embodiment of the radiation CT imaging apparatus of the present invention.

FIG. 6 illustrates another embodiment of the mounting table.

FIG. 7 illustrates floor surface grooves provided in a floor surface.

FIG. 8 illustrates another embodiment of the imaging body unit.

FIG. 9 is a perspective view of a second embodiment of a radiation CT imaging apparatus of the present invention, illustrating a schematic configuration thereof.

### DESCRIPTION OF THE PREFERRED EMBODIMENTS

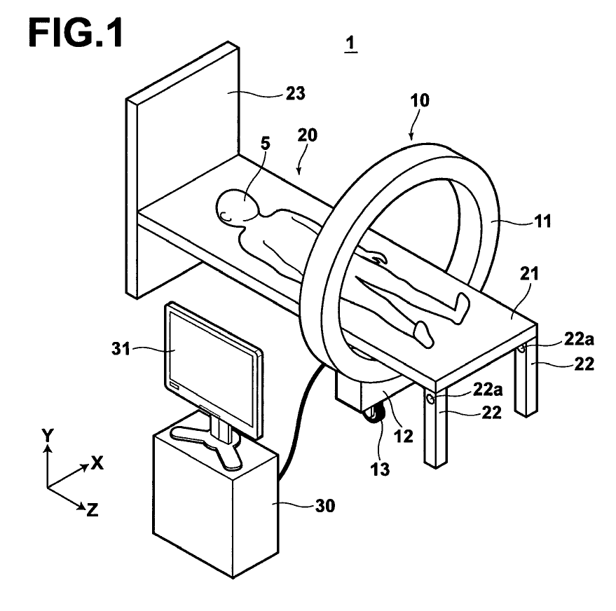

Hereinafter, a first embodiment of the radiation CT imaging apparatus of the present invention will be described with reference to the accompanying drawings. FIG. 1 is a perspective view of radiation CT imaging apparatus 1, illustrating a schematic configuration thereof.

As shown in FIG. 1, radiation CT imaging apparatus 1 includes portable imaging unit 10 having fixed gantry 11 in which a plurality of radiation sources for emitting radiation and a plurality of radiation detectors for detecting radiation transmitted through subject 5 are integrally provided, mounting table 20 on which subject 5 is placed, and image signal processing unit 30 that generates and displays a tomographic image of subject 5 based on radiation image signals detected by the radiation image detectors of portable imaging unit 10.

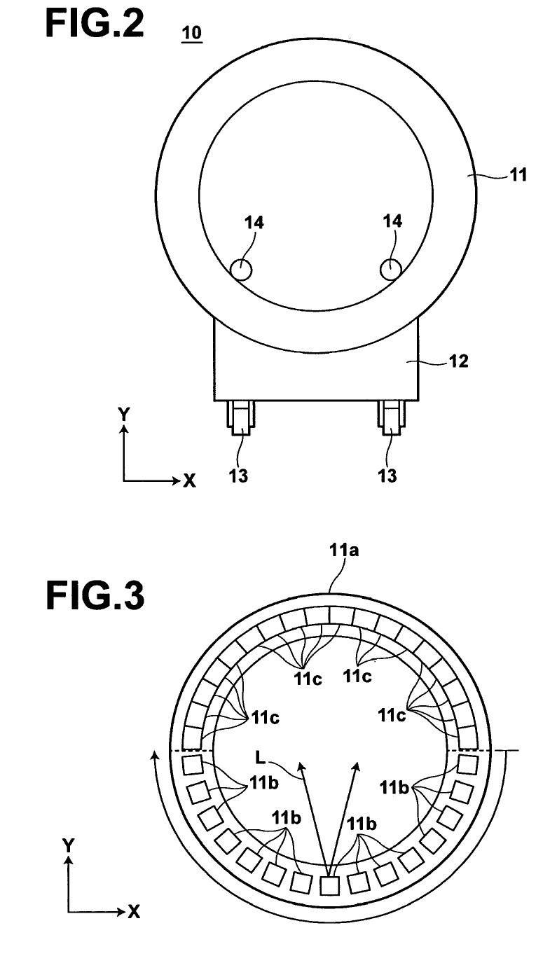

FIG. 2 is an X-Y plan view of portable imaging unit 10. As shown in FIGS. 1 and 2, portable imaging unit 10 includes fixed gantry 11 having a plurality of radiation sources and radiation detectors inside thereof, base 12 for supporting fixed gantry 11, and casters 13 attached to base 12.

FIG. 3 schematically illustrates the inside of fixed gantry 11. As shown in FIG. 3, fixed gantry 11 has a cylindrically shaped housing 11a, and a plurality of radiation sources 11b is provided inside of a semi-circumferential portion of housing 11a such that radiation is emitted toward the central axis. Inside of the other semi-circumferential portion of housing 11a is a plurality of radiation detectors 11c disposed at positions opposite to radiation sources 11b.

Fixed gantry 11 is fixedly mounted on base 12 without any rotation mechanism. Fixed gantry 11 and base 12 are movable by casters 13 attached to the base.

Each radiation source 11b of fixed gantry 11 is a high-speed switching type small radiation source employing a small field emission electron source. Radiation sources 11b are controlled by a not shown control unit and sequentially switched, for example, in the arrow direction shown in FIG. 3 to emit radiation L toward the central axis of fixed gantry 11, i.e., toward subject 5. Preferably, radiation L emitted from each radiation source 11b is a fan beam, as shown in FIG. 3. Radiation sources 11b may be switched one source or a plurality of sources at a time. When a plurality of radiation sources is switched at a time, they are switched such that radiation emitted from radiation sources driven at the same time does not overlap with each other on the detection surface of radiation detector 11c. The radiation emitted from each radiation source 11b is transmitted through subject 5 and detected by radiation detector 11c located at a position opposite to each radiation source 11b. The radiation image signal detected by each radiation detector 11c is sequentially outputted to image signal processing unit 30. Radiation detector 11c is a semiconductor detector and a conventional detector may be used as the detector 11c so that it will not be elaborated upon further here. A plurality of arrays of radiation image detectors 11c may be provided in a direction in which the central axis is extending (Z direction). If that is the case, the irradiation area of radiation emitted from each radiation source 11b covers the detection surfaces of the plurality of arrays of radiation image detectors 11c.

In fixed gantry 11 of the present embodiment, radiation sources 11b and radiation detectors 11c are provided along semi-circumferences respectively, but they may be provided along the entire circumference respectively.

Further, fixed gantry 11 has rotatable spherical ball members 14 on the inner cylindrical surface, as shown in FIG. 2. The purposes of ball members 14 are to support mounting table 20 when it passes an inner cylinder side of fixed gantry 11 and to smooth the movement of fixed gantry 11 by reducing the friction between fixed gantry 11 and mounting table 20. Ball member 14 is fitted in groove 21a to be described later. In the present embodiment, a spherical ball is used as ball member 14, but any member may be used as long as it is capable of smoothing the movement of fixed gantry 11 by reducing the friction between fixed gantry 11 and mounting table 20, and, for example, a roller member may be used.

Image signal processing unit 30 has a tomographic image generation unit that receives a radiation image signal outputted from each radiation detector 11c of fixed gantry 11 and generates a tomographic image based on the radiation image signal. The tomographic image generation unit generates a tomographic image based on an algorithm taking into account the geometrical layout of radiation sources 11b and radiation detectors 11c. Then, a signal representing the tomographic image generated in the tomographic image generation unit is outputted to monitor 31 and the tomographic image of subject 5 is displayed on the screen of monitor 31.

Mounting table 20 includes mounting board 21 on which subject 5 is placed, legs 22 attached on the lower surface of mounting board 21, and a support plate 23 supporting the end of mounting board 21 opposite to the end where legs 22 are attached.

Leg 22 is turnably provided and foldable to the underside of mounting board 21.

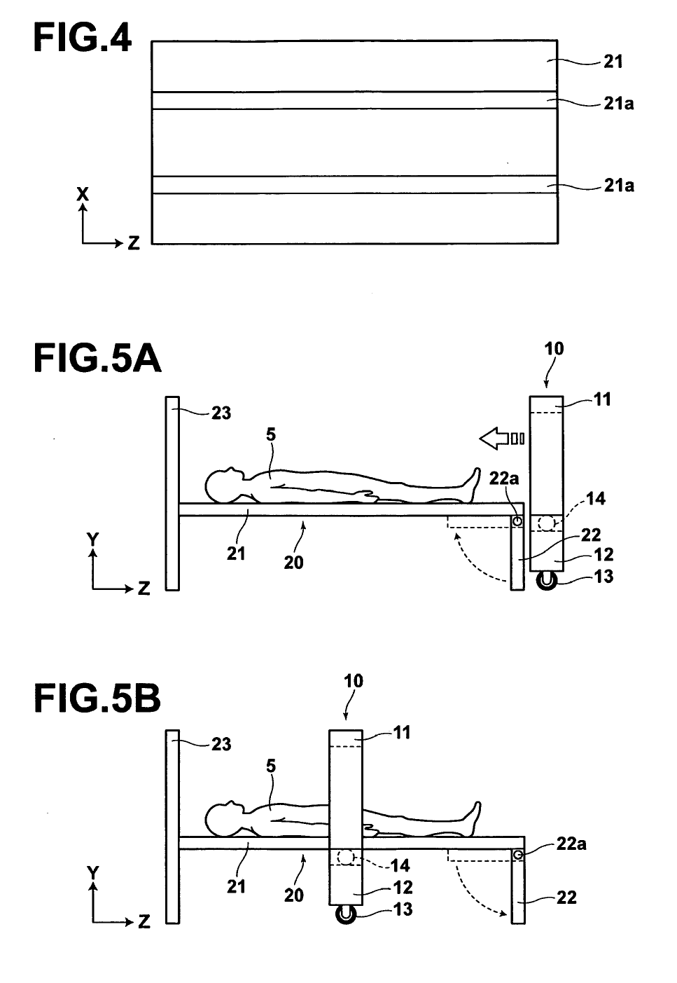

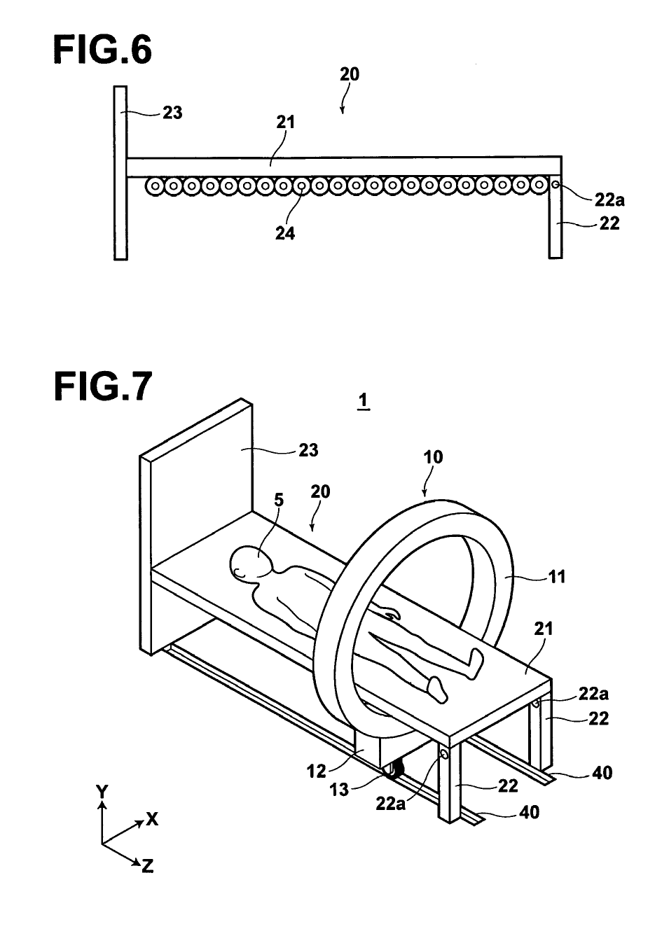

As illustrated in FIG. 4, grooves 21a are formed in the lower surface of mounting board 21 in the longitudinal direction of the board (Z direction in FIGS. 1 and 4). Grooves 21a are formed so as to fittingly receive ball members 14 of portable imaging unit 10 respectively.

Preferably, mounting board 21 is formed of a material having a low radiation absorption rate, such as wood, aluminum, carbon, carbon fiber reinforced resin. The term “material having a low radiation absorption rate” as used herein refers to a material formed of a substance of low atomic number and has a low density, that is, a material having a small linear attenuation coefficient and, for example, a material having a linear attenuation coefficient equal to or smaller than that of aluminum is preferably used.

An operation of radiation CT imaging apparatus 1 according to the first embodiment will now be described.

First, as illustrated in FIG. 5A, subject 5 is placed on mounting board 21 of mounting table 20. Then, portable imaging unit 10 is moved near mounting table 20 by casters 13, and further moved into mounting table 20 from the side of legs 22 such that mounting board 21 passes an inner cylinder side of fixed gantry 11.

Here, the position of portable imaging unit 10 is adjusted such that ball members 14 provided on the inner cylindrical surface of fixed gantry 11 fit into grooves 21a of mounting board 21 respectively. Then, portable imaging unit 10 is further moved in the arrow direction in FIG. 5A (longitudinal direction of mounting table 20) with ball members 14 fitted in grooves 21a. Here, legs 22 of mounting table 20 are folded to the underside of mounting board 21, i.e., the dotted-arrow direction in FIG. 5A and mounting board 21 is held by ball members 14 of portable imaging unit 10.

Thereafter, as illustrated in FIG. 5B, portable imaging unit 10 is further moved to a desired imaging region of subject 5. When the portable imaging unit 10 is moved to the desired imaging region of subject 5, imaging for obtaining a tomographic image of subject 5 is started. More specifically, radiation sources 11b are controlled by a not shown control unit, whereby radiation sources 11b are sequentially switched and radiation is emitted from each radiation source 11b to expose subject 5. The radiation emitted from each radiation source 11b is transmitted through subject 5 and detected by radiation detector 11c located at a position opposite to each radiation source 11b. The radiation image signal detected by each radiation detector 11c is sequentially outputted to image signal processing unit 30.

Then, in the tomographic image generation unit of image signal processing unit, an image signal representing a tomographic image is generated based on the inputted radiation image signal and the image signal is outputted to monitor 31, which displays a tomographic image of subject 5 as a diagnostic image based on the inputted image signal.

After imaging of a tomographic image of the predetermined imaging region is completed, portable imaging unit 10 is further moved in the arrow direction in FIG. 5A and imaging of a next tomographic image is started. As portable imaging unit 10 is moved with ball members 14 of fixed gantry 11 fitted in grooves 21a of mounting board 21 as described above, portable imaging unit 10 may be moved without positional displacement with respect to subject 5 in the X-Y surface in FIG. 1. That is, a tomographic image obtained at each position by moving portable imaging unit 10 may be aligned.

Thereafter, as portable imaging unit 10 is further moved, tomographic images of subject 5 at desired positions are sequentially obtained and displayed on the screen of monitor 31.

In the radiation CT imaging apparatus of the first embodiment, ball members 14 are provided on the inner cylindrical surface of fixed gantry 11 in order to smooth the movement of fixed gantry 11 by reducing the friction between portable imaging unit 10 and mounting table 20. Alternatively, for example, multiple rolling members 24 may be provided on the lower surface of mounting board 21 of mounting table 20 in the longitudinal direction. As for rolling members 24, rotatable rollers or rotatable ball members may be preferably used. Further, a groove for fittingly receiving rolling member 24 may be formed in the inner cylinder side of fixed gantry 11.

Further, in the radiation CT imaging apparatus of the first embodiment, grooves are provided in the lower surface of mounting board 21 or in the inner cylinder side of fixed gantry 11 in order to align tomographic images of subject 5. Alternatively, for example, floor grooves 40 for fittingly receiving casters 13 of portable imaging unit 10 may be formed in the floor of a room where mounting table is installed in the longitudinal direction of mounting board 21, as illustrated in FIG. 7. By moving portable imaging unit 10 with casters 13 thereof fitted in floor grooves 40, portable imaging unit 10 may be moved without positional displacement with respect to subject 5 in the X-Y surface in FIG. 7, and a tomographic image obtained at each position by moving portable imaging unit 10 may be aligned.

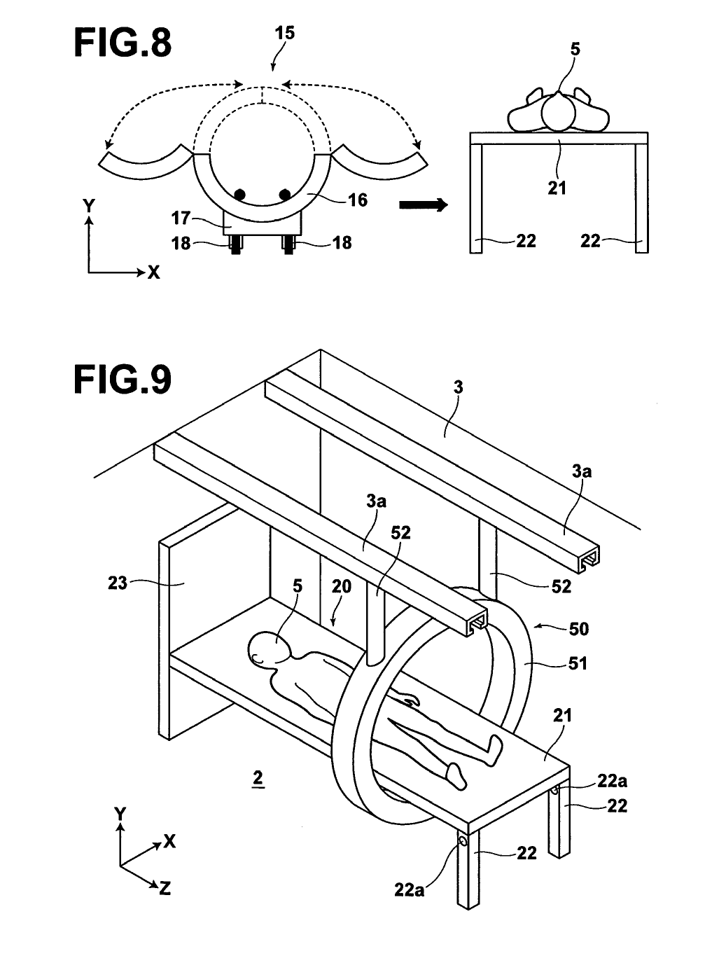

Still further, in the radiation CT imaging apparatus of the first embodiment, mounting board 21 is allowed to pass through the inner cylinder side of fixed gantry 11 by folding legs 22 of mounting table 20. Alternatively, for example, an upper side portion of fixed gantry 16 of main imaging unit 15 is divided into halves so as to open up to the outer side of the cylinder and to close toward the inner side of the cylinder, as illustrated in FIG. 8. Then, as illustrated in FIG. 8, main imaging unit 15 may be moved in the arrow direction with the divided portions of fixed gantry 16 being opened up to the outer side of the cylinder so as to be set under mounting board 21 and then the divided portions may be closed toward the inner side of the cylinder again, whereby tomographic image taking may be performed. Fixed gantry 16 is mounted on base 17, and base 17 has casters 18 capable of moving main imaging unit 15 in the arrow direction in FIG. 8.

A second embodiment of the radiation CT imaging apparatus of the present invention will now be described.

In radiation CT imaging apparatus 1 of the first embodiment, fixed gantry 11 is made movable by equipping portable imaging unit 10 with casters 13. While in radiation CT imaging apparatus 2 of the second embodiment, fixed gantry 51 is made movable by equipping fixed gantry 51 of main imaging unit 50 with arm members 52 and moving the arm members 52, as illustrated in FIG. 9.

More specifically, each arm member 52 is connected to fixed gantry 51 at one end and movably held by rail 3a at the other end. Rails 3a are provided on the ceiling of a room where mounting table 20 is installed running in the longitudinal direction of mounting table 20.

In radiation CT imaging apparatus 2 of the second embodiment, fixed gantry 51 is moved in the longitudinal direction of mounting table 20 by moving arm members 52 along rails 3a provided on ceiling 3.

Then, as in the radiation CT imaging apparatus of the first embodiment, tomographic images are obtained sequentially by moving main imaging unit 50.

Other configurations and operation of radiation CT imaging apparatus 2 are identical to those of radiation CT imaging apparatus 1 of the first embodiment described above.

What is claimed is:

1. A radiation CT imaging apparatus, comprising a plurality of radiation sources, a plurality of radiation detectors, each provided at a position opposite to each radiation source, for detecting radiation emitted sequentially from each radiation source and transmitted through a subject, and a tomographic image generation unit for generating a tomographic image of the subject based on radiation image signals detected by the plurality of radiation detectors, wherein:
the plurality of radiation sources and the plurality of radiation detectors are integrated into a main imaging unit; and
a moving member is further provided to the main imaging unit for making the main imaging unit movable.

2. The radiation CT imaging apparatus of claim 1, wherein:
the apparatus further comprises a mounting table having a mounting board on which the subject is placed and a leg attached to a lower surface of the mounting board;
the main imaging unit is formed in a cylindrical shape; and
the leg of the mounting board is configured to be folded when the mounting table passes an inner cylinder side of the cylindrically shaped main imaging unit and the mounting board is configured to be placed on an inner cylindrical surface.

3. The radiation CT imaging apparatus of claim 2, wherein a rotatable rolling member for holding the mounting board is provided on the lower surface of the mounting board or on the inner cylinder surface of the main imaging unit.

4. The radiation CT imaging apparatus of claim 2, wherein:
a rotatable rolling member for holding the mounting board is provided on the inner cylinder surface of the main imaging unit; and
a groove for fittingly receiving the rolling member is formed in the lower side of the mounting board running in a longitudinal direction of the board.

5. The radiation CT imaging apparatus of claim 2, wherein a floor groove for fittingly receiving the moving member is formed in a floor, on which the mounting table is installed, running in a longitudinal direction of the mounting board.

6. The radiation CT imaging apparatus of claim 2, wherein the mounting board is formed of a material having a low absorption rate for the radiation.

7. A radiation CT imaging apparatus, comprising a plurality of radiation sources, a plurality of radiation detectors, each provided at a position opposite to each radiation source, for detecting radiation emitted sequentially from each radiation source and transmitted through a subject, and a tomographic image generation unit for generating a tomographic image of the subject based on radiation image signals detected by the plurality of radiation detectors, wherein:
the plurality of radiation sources and the plurality of radiation detectors are integrated into a main imaging unit; and
an arm member, having a first end connected to the main imaging unit and a second end to be movably held, and a rail for movably holding the arm member are further provided.

8. The radiation CT imaging apparatus of claim 7, wherein the rail is provided on a ceiling of a room.
